(19) United States
(12) Patent Application Publication
(10) Pub. No.: US 2004/0003018 A1
(43) Pub. Date: Jan. 1, 2004

(54) Method and system for efficient handlings of serial and parallel java operations

(76) Inventors: Vladimir M. Pentkovski, Folsom, CA (US); Hsien-Cheng E. Hsieh, (US); Chien-Yu Hung, Gold River, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/183,089

(22) Filed: Jun. 26, 2002

(51) Int. Cl. G06F 9/00

(52) U.S. Cl. 709/100

(57) ABSTRACT

A system for managing Java threads to decrease the time expended by a central processing unit executing any instructions that will manage threads. I/O operations are offloaded to a serial processor. General computing streams are primarily processed in parallel operations.

### FIELD OF INVENTION

The present invention relates to Java processing and more particularly to efficient handling of data and instructions for parallel and serial processing.

### BACKGROUND OF THE INVENTION

Business transaction processing systems include webservers and application servers. An important form of programming for such systems is Java™ object-oriented language basic unit of program execution is a thread. Processes can have several threads running concurrently, each performing a different job, such as waiting for events or performing a time-consuming job that the program does not need to complete before going on. Normally, central processing units (CPUs) take a significant portion of their time on thread management. Thread management includes such tasks as management of queues, synchronization, wake-up and put-to-sleep the threads, and many other well-known and not well-known processes. Systems may have a very high thread count, for example in the thousands. A system can be slowed down significantly because of the overhead due to the additional compilation steps required to manage the thousands of threads. Overhead is the time spent executing any instructions that will manage the threads.

A prior approach to solution of thread management has been to substantially discard a technique of new threads and using a single or very few basic processes to handle all transaction requests. However, this technique results in provision of poor scalability on multi-processor systems. Special tuning of a system may be necessary in order to get reasonable performance.

### BRIEF DESCRIPTION OF THE DRAWINGS

The present invention is described in the specification taken in connection with the following drawings. The embodiments illustrated are exemplary and not exhaustive.

Of the drawings:

FIG. 1 is a block diagrammatic representation of a system operating in accordance with the present invention;

FIG. 2 is a partial detailed view of the system of FIG. 1;

FIG. 3 is a block diagram illustrating data flow within the system of FIG. 1;

FIG. 4 is a partial detailed view of the system of FIG. 1 illustrative of an alternative to the use of the Java co-processor 20 as illustrated in FIG. 1; and

FIG. 5 illustrates a Java software stack utilized in the present invention.

FIG. 6 is a flowchart illustrating dynamic partitioning to rearrange use of resources.

### DETAILED DESCRIPTION

FIG. 1 illustrates a server 1 embodying the present invention. A system bus 10 couples system components to a main central processing unit (CPU) 12. CPU 12 may contain one or more processors. A system memory 14 comprises random-access memory (RAM). Interacting with the CPU 12 is a Java co-processor (JCP) 20. The JCP 20 as further described below, can take a number of different forms. In FIG. 1, the JCP 20 is a thread controller JCP 20.

The thread controller 20 is connected to input output (I/O) unit 22 which may, for example, include networking network interface cards (NICs) 23 and disk controllers 24. A number of different well-known subsystems could be included in the I/O unit 22. The included components are illustrated as being in the I/O unit 22 for convenience. This is not necessary, however. Many different physical implementations may be provided consistent with the block diagrammatic representation of FIG. 1.

The embodiment of FIG. 1, utilizing a Java co-processor, is preferred for systems that require best performance. An example of such a system is a high-end Itanium™ family Processor system by Intel. The Java co-processor 20 can be implemented as a stand-alone chip and supporting memory and I/O interface chips. The Java co-processor 20 can reside on either the system board or be integrated with an intelligent I/O-and-card.

In general, a processor must handle both I/O strings and other, general computing streams. The general computing strings can be processed in a parallel manner to a large degree. However, I/O processing tends to be serial in nature. In the present system, speed-up is achieved by off-loading serial operations to a separate processor. In the embodiment of FIG. 1, this processor is the thread controller JCP 20. Processing must be serial and since modern CPUs tend to be slower, I/O processing is often limited by CPU external bus speed.

A Java processing paradigm limits I/O processing to only a subset of available system processing elements. According to Amdahl's Law, system speed-up is limited by the amount of serial processing that must be done.

FIG. 2 shows traditional partitioning where I/O processing is not off-loaded to a designated processor, but rather utilizes all available CPUs on a par with general computing.

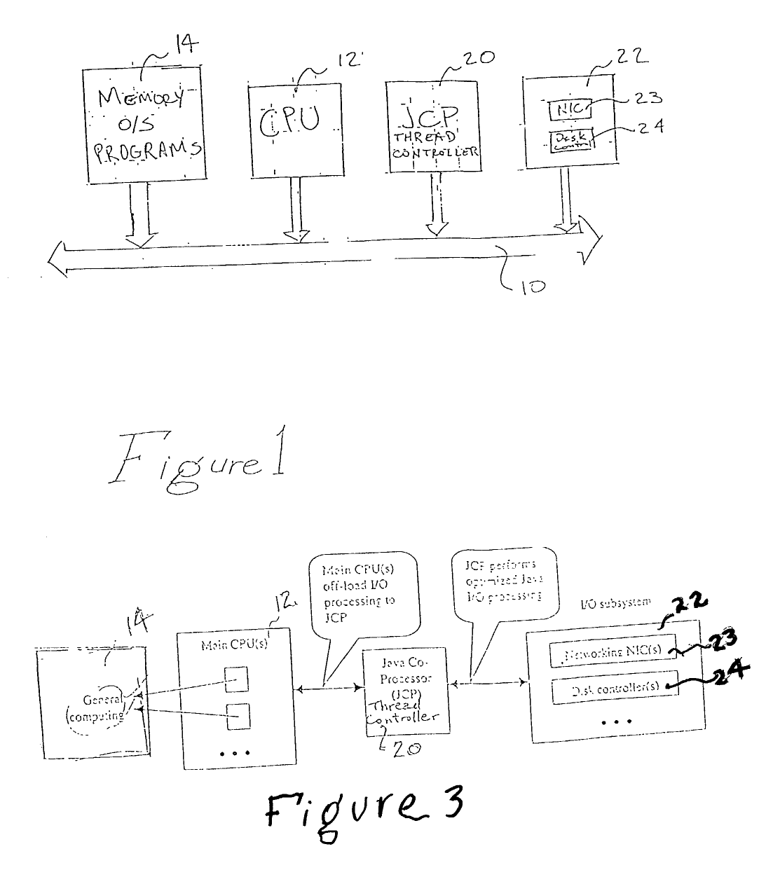

FIG. 3 is a block diagram illustrating data flow within the system of FIG. 1. Many different hardware arrangements can provide the same data flow. The CPU 12 separates I/O strings from general computer strings. The general computing strings are processed as for example by interaction with the memory 14. I/O processing is off-loaded by the CPU 12 to the JCP 20. The JCP 20 performs optimized Java I/O processing and provides management signals to the I/O unit 22 including the network interface cards 23 and disk controllers 24.

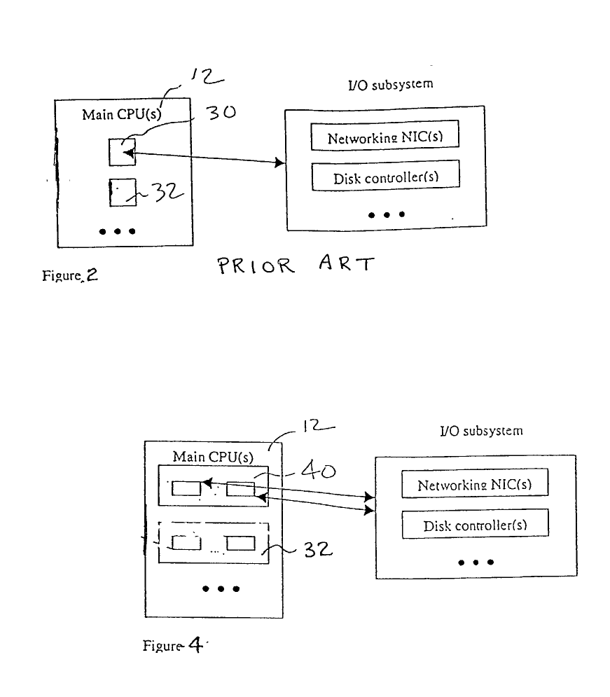

FIG. 4 is an illustration showing a further form of Java processor as an alterative to the JCP 20 of FIG. 1. A multiprocessor 40 included within the main CPU 12 but dedicated to handle serial processing of Java I/O threads. An example of a suitable multiprocessor 40 is a multi-threaded CPU. Alternatively, the multiprocessor 40 may comprise a chip multi-processing (CMP)CPU.

In operation, the general computing and I/O computing operations of the Java processing are performed asynchronously and are linked by special software that synchronizes the two forms of processing. When the amount of I/O processing in the system is below a certain a threshold, dynamic dispatching can be done to reclaim the CPUs or threads previously allocated for performing Java I/O processing.

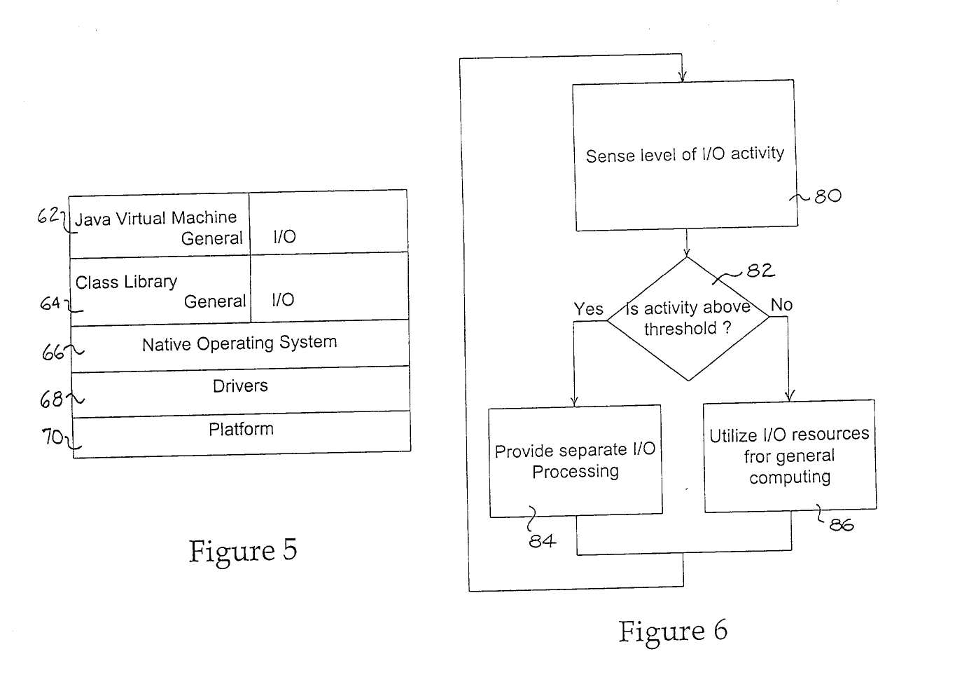

A Java software stack is illustrated in FIG. 5. A software stack 60 includes a Java virtual machine (JVM) 62, a class library 64, a native operating system 66 and drivers (driver software) 68 running on a platform 70. The Java software stack, described below with respect to FIG. 5, needs to be carefully partitioned into Java and I/O processing portions. This is illustrated by the vertical divisions in the layers representing Java virtual machine 62 and class library 64. The I/O portions for example that read contents of a file on a disk, can be bound to the Java co-processor 20 in the embodiment of FIG. 1. General computing as illustrated is performed portions 32 of the CPU 12 not performing I/O processing.

As illustrated in FIG. 6, which is a flowchart, dynamic partitioning may be utilized to rearrange use of resources. In the embodiments of FIGS. 3 and 4, dynamic dispatching can be utilized to reclaim the CPUs or threads previously allocated to Java I/O processing if it is detected that the amount of I/O processing in the system is below a certain threshold.

Referring to block 80, the level of I/O activity is sensed. If it is above a pre-selected threshold, as measured at block 82, memory assignments are maintained as described above. As seen at block 84, separate I/O processing is maintained. If a block 82, a low operation proceeds to block 86 I/O processing resources are utilized for general computing.

FIG. 6 is a block diagrammatic representation of the operation and synchronization of the general computing and I/O computing performed within the CPU 12 and the present embodiment.

In the present system, Java I/O processing is off-loaded from general computing processes. Consequently, the speed of general computing can be improved. The demand of the serial stream of Java I/O inputs do not burden processing of general functions. Consequently, the speed of Java processing is increased.

The foregoing description will enable those skilled in the art to make many modifications in accordance with the present invention.

What is claimed is:

1. A thread controller in a processor comprising:
a processor separating general computing operations and I/O processing threads, a separate processor to process I/O threads, said separate processor being connected to said I/O processor, and said I/O processor interconnecting with an input/output unit.

2. The thread controller according to claim 1 wherein said input/output unit comprises networking interface cards and disk controllers.

3. The thread controller according to claim 1 wherein said I/O processor comprises a Java co-processor.

4. The thread controller according to claim 1 wherein said I/O processor comprises a dedicated processor within said first processor.

5. The thread controller according to claim 1 wherein said first processor measures I/O activity in comparison to a pre-selected threshold and interconnects first processor and said I/O processor to release the I/O processor from dedicated I/O processing and said I/O activity is below a pre-selected threshold.

6. A method comprising:
receiving a plurality of computer instructions to be performed;
separating general computing instructions from I/O functions;
providing said I/O instructions to a separate processor to be processed; and
operating input/output devices in communication with said I/O processor.

7. The method according to claim 6 wherein said computing instructions are processed in parallel form and said I/O instructions are processed in serial fashion.

8. The method of claim 7 wherein providing said I/O instructions to a processor comprises providing said instructions to a Java co-processor.

9. The method according to claim 7 wherein providing said instructions to an I/O processor comprises providing said instructions to a dedicated processor in a main CPU.

10. The method according to claim 7 further comprising partitioning a software stack to process the instructions into general computing and I/O sections.

11. The method according to claim 10 further comprising monitoring I/O activity and releasing the I/O processor from dedicated I/O service when I/O activity is below a pre-selected threshold.

12. A machine-readable medium that provides instructions which, when executed by a processor, cause said processor to perform operations comprising:
receiving a plurality of computer instructions to be performed;
separating general computing instructions from I/O functions;
providing said I/O instructions to a separate processor to be processed; and
operating input/output devices in communication with said I/O processor.

13. A machine-readable medium according to claim 12 that provides instructions which when operated by a processor said computing instructions are processed in parallel form and said I/O instructions are processed in serial fashion.

14. A machine-readable medium according to claim 13 that provides instructions which, when executed by a processor, cause said processor to perform operations wherein providing said I/O instructions to a processor comprises providing said instructions to a Java co-processor.

15. A machine-readable medium according to claim 13 that provides instructions which, when executed by a processor, cause said processor to perform operations wherein providing said instructions to an I/O processor comprises providing said instructions to a dedicated processor in a main CPU.

16. A machine-readable medium according to claim 13 that provides instructions which, when executed by a processor, cause said processor to perform operations comprising partitioning a software stack to process the instructions into general computing and I/O sections.

17. A machine-readable medium according to claim 13 that provides instructions which, when executed by a processor, cause said processor to perform operations further comprising monitoring I/O activity and releasing the I/O processor from dedicated I/O service when I/O activity is below a pre-selected threshold.
